(19) United States
(12) Patent Application Publication
(10) Pub. No.: US 2021/0029965 A1
(43) Pub. Date: Feb. 4, 2021

(54) Water Trough Heating Apparatus

(71) Applicant: Ryan Luther, Drake, CO (US)

(72) Inventor: Ryan Luther, Drake, CO (US)

(21) Appl. No.: 16/944,808

(22) Filed: Jul. 31, 2020

Related U.S. Application Data
(60) Provisional application No. 62/881,605, filed on Aug. 1, 2019.

(51) Int. Cl. A01K 7/02

(52) U.S. Cl. CPC A01K 7/027

(57) ABSTRACT

A heating apparatus according to the present disclosure maintains the temperature of water in a trough. The heating apparatus comprises a body configured to be submerged in the trough, the body having a pump and a heating element affixed in the body, the pump configured to draw water into an intake port at a first end of the body past the heating element to heat the water and return the water through an outlet port at a second end of the body; a sensor monitoring the temperature of the water in the trough; and a control module. The control module is configured to activate either the pump or the heating element when the temperature of the water is less than a predetermined low temperature. The control module is configured to deactivate the pump or the heating element when the temperature of the water is greater than a predetermined high temperature.

### CROSS-REFERENCE TO RELATED APPLICATION

This application claims priority to U.S. Provisional Patent App. No. 62/881,605 titled Apparatus and Method for Heating Contents of a Trough, the disclosure of which is hereby incorporated by reference.

### FIELD

This application relates to the farming and livestock industry, and, more particularly, to a device that prevents water in a trough or tank from freezing in cold climates.

### BACKGROUND

A water trough or tank is a manufactured or natural receptacle intended to provide drinking water to animals. Water troughs are typically seen on farms and rural areas to provide water to livestock or wild animals. However, during cold weather, there is a risk that the water in the trough will freeze. The result is the animals or livestock will be unable to obtain water from their usual water source for extended periods.

In order to create a single water source that may be accessible to livestock or wild animals year round, there is a need for maintaining the water in the trough in a liquid form and at a desirable temperature. In addition, the apparatus may be self-contained with a power source and not need to be connected to an alternating current source.

### SUMMARY

The present disclosure provides an apparatus and method for controlling the temperature of water in a water trough in order to maintain liquid water during colder months. Thereby ensuring that animals and livestock will have a suitable water source at all times.

In some embodiments, the water trough heating apparatus is able to regulate itself based on sensing either atmospheric temperature or the temperature of the water in the trough. In one exemplary embodiment, this may be achieved by a thermostat that opens a circuit when the water temperature is sensed to be 55 degrees Fahrenheit or higher thereby turning off the power source and disabling the water trough heating apparatus. Then, the thermostat closes the circuit when the temperature falls below 35 degrees Fahrenheit thereby turning on the power source and activating the Water Trough Heating Apparatus.

In some embodiments, the water trough heating apparatus may be powered by direct current (DC) power source. For example, in remote areas where an alternating current (AC) source is not available or requires an undesirable or unreasonable length of extension cords.

At another end of the flow through housing, there may be an outlet port. The outlet port directs the warm water out of the flow through housing and back into the trough. Thus, heated water returned to the trough or tank will increase the temperature of the water in the trough or tank.

In one exemplary embodiment the trough heating apparatus includes a body configured to be submerged in the trough, and the body has an intake port, an outlet port, a pump, and a heating element. The heating element may be a direct current heating element or a heating coil. The pump draws the liquid into the body via the intake port and past the heating element before returning the liquid to the trough via the outlet port to maintain the temperature of the liquid. A control module and a sensor are powered by either direct current or alternating current power source is in electrical communication with the pump, heating element, and sensor. The control module is configured to activate or deactivate the pump or the heating element based on temperature information collected by the sensor.

In some embodiments, the sensor is configured to detect a depth of the liquid in the trough and transmit a signal to the control module to deactivate the pump or the heating element if the depth falls below a predetermined low height or value. By way of example, the predetermined low value may be the distance from the bottom of the trough to the top of the intake port.

In some embodiments, a filter is affixed to the body. The filter may strain debris out of the liquid before it is returned to the trough. The filter may also prevent debris from contacting the heating element which could pose a fire hazard or decrease the heating efficiency.

In another exemplary embodiment, a heating apparatus for heating liquid contents in a trough includes a body having an intake port located at a first end and an outlet port located at a second end. The intake port and the outlet port are in fluid connection via a channel or flow-through tunnel in the body. The body is configured to be submerged within the liquid contents of the trough. A pump is affixed to the body and configured to draw water from the trough into the boyd. A heating element is affixed within the channel.

In another exemplary embodiment, the heating apparatus has a temperature sensor configured to monitor the temperature of the liquid and a depth sensor configured to monitor a depth of the liquid contents. A control module is in communication with the pump, the heating element, the temperature sensor, and the depth sensor. When the temperature sensor detects that the temperature of the liquid contents is less than a predetermined low temperature, the control module is configured to activate the pump and the heating element. When the temperature sensor detects that the temperature of the liquid contents is greater than a predetermined high temperature, the control module is configured to deactivate the pump and the heating element.

In some embodiments, the depth sensor may be a float sensor.

In another exemplary embodiment, the control module is configured to deactivate the pump and the heating element when the depth sensor detects that the depth of the liquid contents is less than a predetermined low depth.

In another exemplary embodiment, the control module is configured not to activate the pump and the heating element unless the temperature sensor detects that the temperature is less than a predetermined low temperature and the depth sensor detects that the depth is greater than a predetermined safe depth.

### BRIEF DESCRIPTION OF THE DRAWINGS

FIG. 1 illustrates a water trough heating apparatus according to an exemplary embodiment attached to a trough with body submerged in the water;

FIG. 2 illustrates a side cutaway view of the body according to an exemplary embodiment;

FIG. 3 illustrates another cutaway view of the body according to an exemplary embodiment; and

FIG. 4 illustrates a view of the water pump according to an exemplary embodiment.

### DETAILED DESCRIPTION

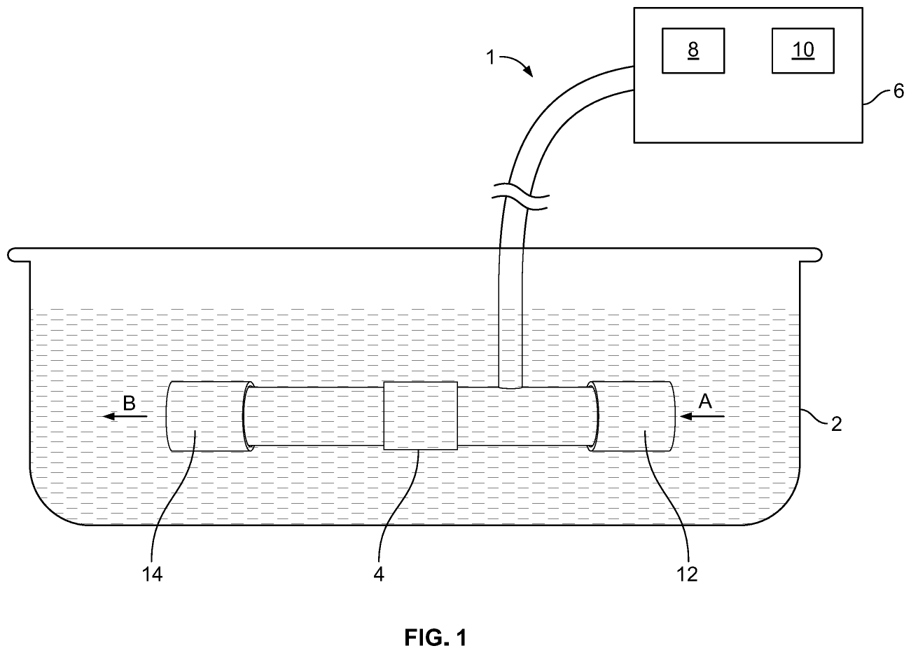

Referring to FIG. 1, one exemplary embodiment of the water trough heating apparatus 1 is shown affixed to a trough 2. In the illustrated embodiment, the Water Trough Heating Apparatus 1 includes a body 4 connected to a control module 6. The control module 6 has a power source 8 and a temperature controller 10. The body 4 submerged in the trough 2 and water flows into the body 4 through intake port 12 (Arrow A) to be heated within the body 4 and heated water flows back out into the trough through an outlet port or return port 14 (Arrow B) to control the temperature of water in the trough 2.

The power source 8 may be a direct current power source (such as a 12 or 24 Volt battery, or a deep cycle battery), alternating current power source, a solar panel, wind mill or other suitable power source. In one exemplary embodiment, the power source 8 is a rechargeable battery connected to a solar panel with a built-in charge regulator to guard against overcharging.

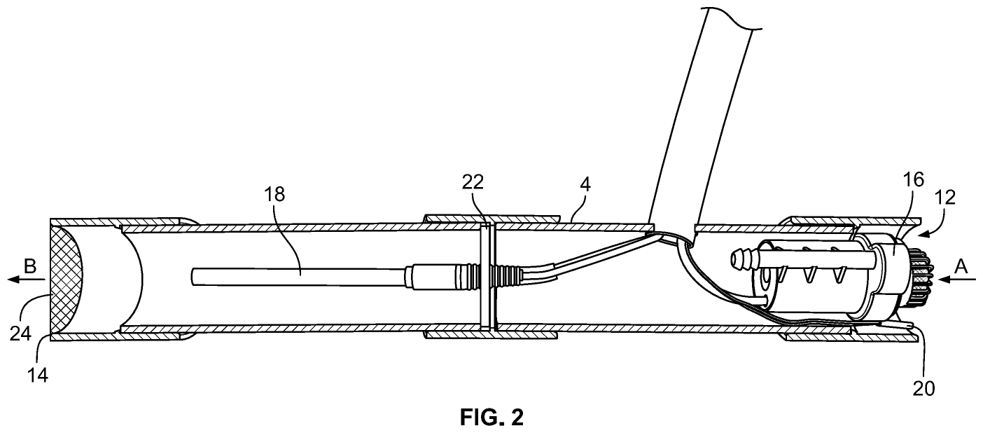

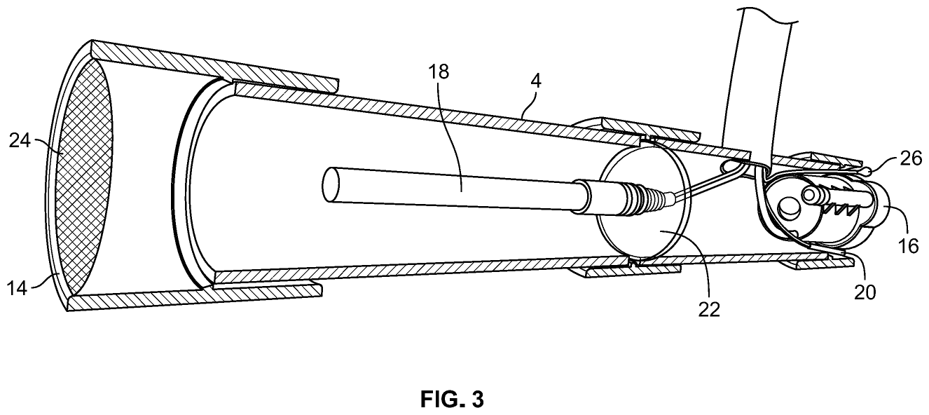

Referring now to FIGS. 2 and 3, a cutaway view of the body 4 of the exemplary water trough heating apparatus 1 is shown. The body 4 may include an intake port 12, an return port 14, a pump 16, a heating element 18, and a sensor 20. Generally, when the body 4 is submerged in the trough 2, the pump 16 draws water into the intake port 12 to pass through the body 4 passing the heating element 18 to warm the water and then back into the trough 2 through return port 14. The heating element 18 may be at least partially submersible in the water or may be completely submerged. In one exemplary embodiment, the heating element 18 is mounted 22 within the body 4. In another exemplary embodiment, the return port 14 includes a filter 24 to strain debris out of the water before returning it to the trough 2.

In another embodiment, the sensor 20 monitors the temperature of the water and communicates that information to the control module 6 for the control module 6 to then activate or deactivate either the heating element 18 or the pump 16. In another embodiment, the sensor 20 communicates the temperature of the water to a temperature controller 10 and the temperature controller 10 then sends a signal to the control module 6 to direct the control module 6 to activate or deactivate the pump 16 or the heating element 18. When the water in the trough 2 drops below a predetermined temperature, the control module 6 may activate the pump 16 and heating element 18 to heat the contents of the trough 2. In another exemplary embodiment, the sensor 20 monitors water temperature and the temperature controller 10 maintains the contents of the trough at a constant temperature by communicating with the control module 6 to activate the pump 16 and heating element 18 as needed to maintain the temperature.

By way of example, the control module 6 in connection with the temperature controller 10 may be programmed to provide variable heating of the water depending on various temperature ranges. In one exemplary embodiment, the temperature controller 10 receives temperature information from the sensor 20. The temperature controller 10 may be programmed to send an activation signal when the temperature of the water falls below a predetermined low temperature value, 55 degrees Fahrenheit for example. Then, the temperature controller 10 may be programmed to send a deactivation signal to the control module 6 when the temperature in the water reaches a predetermined high temperature, 70 degrees Fahrenheit for example. The predetermined high and low temperature values can be changed by a user.

In another exemplary embodiment, instead of sending activate or deactivate signals, the temperature controller 10 sends the temperature information to the control module 6 and the control module 6 is programmed to activate or deactivate the pump or the heating element based on the predetermined high and low temperature values.

In another exemplary embodiment, the sensor 20 may also detect the depth of liquid in the trough. When the sensor 20 detects the water below a predetermined low temperature, the control module 6 activates the pump 16 and heating element 18. When the temperature of the water reaches a predetermined high temperature, the control module 6 turns off the pump 16 and heating element 18. By way of example, in one embodiment, the predetermined low temperature is 35 degrees Fahrenheit and the predetermined high temperature is 55 degrees Fahrenheit.

In another embodiment, the heating apparatus may have a temperature sensor 20 and a depth sensor 26. The depth sensor 26 monitors the depth of water in the trough 2 and is in communication with the control module 6. When the depth sensor 26 detects that the contents of the trough 2 have fallen below a predetermined height or value, the control module 6 turns off the pump 16 and heating element 18. In some embodiments, the control module 6 may not activate unless the depth sensor 26 detects water above the predetermined height. By way of example, the predetermined value may be the distance from the bottom of the trough to the top of body above the intake port 12.

In another embodiment, the depth sensor 26 may be a float sensor. The depth sensor 26 may be in communication either by direct electrical connection or wireless communication (such as Bluetooth). The depth sensor 26 is floating at the surface or the water and detects the distance from the surface of the water from the bottom of the trough. In one exemplary floating embodiment, the depth sensor 26 would then transmit either an on/off or activate/deactivate signal to the control module 6. In another floating embodiment, the depth sensor 26 may transmit the depth information directly to the control module 6.

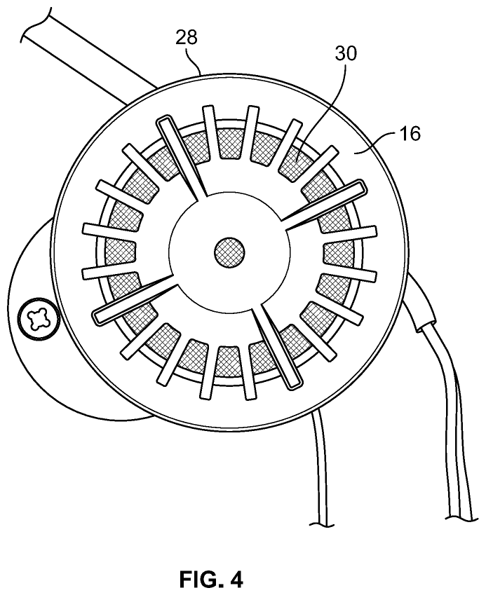

Referring to FIG. 4, a view of the face of the pump 16 is shown according to an exemplary embodiment. The pump 16 may be placed in a secure housing 28 with a filter 30 to prevent debris from damaging the pump 16 during operation.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A trough heating apparatus, the apparatus comprising:
a body configured to be submerged in a liquid in a trough, the body having an intake port, an outlet port, a pump, and a heating element;
a control module, wherein the control module is configured to activate the pump; and
wherein the pump is configured to draw the liquid into the body via the intake port past the heating element and return the liquid to the trough via the outlet port to maintain the temperature of the liquid in the trough.

2. The trough heating apparatus of claim 1, wherein the heating element is a direct current water heating element.

3. The trough heating apparatus of claim 1, further comprising a sensor to detect a temperature of the liquid in the trough and communicate the temperature to the control module.

4. The trough heating apparatus of claim 1, wherein the control module includes a power source.

5. The trough heating apparatus of claim 3, wherein the control module includes a temperature controller, configured to receive temperature information from the sensor and transmit the temperature information to the control module to activate or deactivate at least one of the pump and the heating element based on the temperature information.

6. The trough heating apparatus of claim 5, wherein the sensor is configured to detect a depth of the liquid in the trough and transmit a signal to the control module to deactivate the pump and the heating element.

7. The trough heating apparatus of claim 1, wherein the body includes a filter to strain debris out of the liquid.

8. A heating apparatus for maintaining a temperature of water in a trough comprising:
a body configured to be submerged in the trough, the body having a pump and a heating element affixed in the body, the pump configured to draw water into the body via an intake port at a first end of the body and past the heating element to heat the water and return the water into the trough via an outlet port at a second end of the body;
a sensor configured to monitor the temperature of the water in the trough; and
a control module in communication with the pump, the heating element, and the sensor, the control module configured to activate or deactivate the pump and heating element.

9. The heating apparatus according to claim 8, wherein the control module is configured to activate at least one of the pump and the heating element when the sensor detects that the temperature of the water in the trough is less than a predetermined low temperature.

10. The heating apparatus according to claim 9, wherein the control module configured to deactivate at least one of the pump and the heating element when the sensor detects that the temperature of the water in the trough is greater than a predetermined high temperature.

11. The heating apparatus according to claim 10, wherein the control module includes a power source.

12. The heating apparatus according to claim 8, wherein the sensor is affixed to the body and monitors a depth of the water in the trough.

13. The heating apparatus of claim 12, wherein the control module is configured to deactivate at least one of the pump and the heating element when the sensor detects that the depth of the water in the trough is less than a predetermined low depth of water in the trough.

14. The heating apparatus of claim 13, wherein the body includes a filter to strain debris as the water returns to the trough.

15. A heating apparatus for heating liquid contents in a trough, the heating apparatus comprising,
a body having a pump and a heating element, wherein the body is configured to be submerged within the liquid contents of the trough;
a control module in communication with the pump and the heating element; and
a temperature sensor configured to monitor the temperature of the liquid contents and communicate the temperature to the control module; and
a depth sensor configured to monitor a depth of the liquid contents and communicate the depth to the control module;
wherein the control module is configured to activate the pump and the heating element when the temperature sensor detects that the temperature of the liquid contents is less than a predetermined low temperature;
wherein the control module is configured to deactivate the pump and the heating element when the temperature sensor detects that the temperature of the liquid contents is greater than a predetermined high temperature.

16. The heating apparatus of claim 15, wherein the depth sensor is a float sensor.

17. The heating apparatus of claim 16, wherein the control module is configured to deactivate the pump and the heating element when the depth sensor detects that the depth of the liquid contents is less than a predetermined low depth.

18. The heating apparatus of claim 17, wherein the control module is configured not to activate the pump and the heating element unless the temperature sensor detects that the temperature is less than a predetermined low temperature and the depth sensor detects that the depth is greater than a predetermined safe depth.

19. The heating apparatus of claim 15, wherein the body further comprises:
an intake port located at one end of the body;
an outlet port located at a second end of the body;
a filter affixed near the outlet port to strain debris from the water; and
a channel starting at the intake port running through the body to the outlet port;
whereby the water flows into the body via the intake port through the channel and back to the trough via the outlet port.
